(19) United States
(12) Patent Application Publication
(10) Pub. No.: US 2007/0053312 A1
(43) Pub. Date: Mar. 8, 2007

(54) Pipelined method and apparatus for exchanging information over a wireless network

(76) Inventor: Ran Hay, Rosh Haayin (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/221,423

(22) Filed: Sep. 7, 2005

(51) Int. Cl. H04B 7/00

(52) U.S. Cl. 370/310

(57) ABSTRACT

A method for exchanging information over a wireless network, the method includes: (i) providing a distributed media access controller and a high communication layer component, the high communication layer component includes a high communication layer hardware and a high communication layer software; and (ii) utilizing the distributed media access controller and the high communication layer component to exchange information. The utilizing includes applying a centralized media access control scheme and by the high communication layer component, and maintaining at least one endpoint data structure by the high communication layer software while maintaining at least one transfer operational list data structure by the high communication layer hardware. An apparatus that includes a distributed media access controller and a high communication layer component. The high communication layer component includes a high communication layer hardware and a high communication layer software, and the high communication layer component hardware includes a hardware routine execution module. The distributed media access controller and the high communication layer component are adapted to exchange information. The high communication layer component is adapted to apply a centralized media access control scheme.

### FIELD OF THE INVENTION

The invention relates to methods and apparatuses for exchanging information over a wireless network.

### BACKGROUND OF THE INVENTION

Recent developments in telecommunication and semiconductor technologies facilitate the transfer of growing amounts of information over wireless networks.

The demand for short to medium range, high speed connectivity for multiple digital apparatuses in a local environment continues to rise sharply. For example, many workplaces and households today have many digital computing or entertainment apparatuses such as desktop and laptop computers, television sets and other audio and video apparatuses, DVD players, cameras, camcorders, projectors, handhelds, and others. Multiple computers and television sets, for instance, have become common in American households. In addition, the need for high speed connectivity with respect to such apparatuses is becoming more and more important. These trends will inevitably increase even in the near future.

As the demand for high speed connectivity increases along with the number of digital apparatuses in typical households and workplaces, the demand for wireless connectivity naturally grows commensurately. High-speed wiring running to many apparatuses can be expensive, awkward, impractical and inconvenient. High speed wireless connectivity, on the other hand, offers many practical and aesthetic advantages, which accounts the great and increasing demand for it. Ideally, wireless connectivity in a local environment should provide high reliability, low cost, low interference caused by physical barriers such as walls or by co-existing wireless signals, security, and high speed data transfer for multiple digital apparatuses. Existing narrowband wireless connectivity techniques do not provide such a solution, having problems such as high cost, unsatisfactory data transfer rates, unsatisfactory freedom from signal and obstacle related interference, unsatisfactory security, and other shortcomings. In fact, the state of the art does not provide a sufficiently satisfactory solution for providing high speed wireless connectivity for multiple digital apparatuses in a local environment.

Some of short-range ultra wide band wireless networks are characterized by a distributed architecture in which apparatuses exchange information without being controlled by a central host or a base station. The MBOA (Multi Band OFDM Alliance) include multiple vendors that defined a PHY ultra wide band layer and a distributed MBOA MAC layer. FIG. 1 illustrates an MBOA network 10 that includes three apparatuses—apparatus A 11, apparatus B 12 and apparatus C 13. These apparatuses use an MBOA MAC scheme to coordinate the access to the wireless medium that they share.

Some of the short-range ultra wide band wireless networks use a centralized media access control scheme. The access to the shared wireless medium is determined by a host apparatus that transmits media access control information to the other apparatuses.

Multiple vendors are promoting a Wireless Universal Serial Bus (WUSB) standard. This standard suggests to define a wireless system that includes a single USB host and multiple wireless USB apparatuses. The access to the shared wireless medium is determined by the wireless USB host. FIG. 1 also describes a W USB network 20 that includes wireless USB apparatuses apparatus, E 25, apparatus F 26 and apparatuses G 24, as well as a wireless USB host that is apparatus B 12.

The WUSB standard defines MAC super frames that include two hundred and fifty six media access slots (MAS), each being two hundred and fifty six microseconds long. Each slot includes multiple mini-slots. These mini-slots are also referred to as channel-time-allocation (CTA).

The wireless USB host determines the access to the medium shared by it and the wireless USB apparatuses within its group (or cluster) on a mini-slot basis. The allocation involves transmitting an Micro Scheduled Management Command (MMC) frame that determines the access to the wireless medium during multiple mini-slots within a WUSB DRP reservation.

A typical MMC command includes various fields such as time to the next MMC frame, time slot type (receive, transmit, DNTS), and information (referred to as IE) representing the allocation of mini-slots to various apparatuses. Each IE includes, for example, an endpoint identification information that identifies the endpoint that participates in the information exchange. The IE also includes an information type indication that defines which type of information can be exchanged during that mini-slot.

FIG. 2 illustrates a super frame 30 that includes multiple beacon slots 31, multiple MBOA DRP or MBOA PCA slots (denoted DRP/PCA) that are not allocated for WUSB transmission, and two DRP WUSB slots 32 and 34. The two DRP UWSB slots are dedicated to WUSB transmission. The first DRP WUSB slot 32 includes two MMC frames 40 and 44 and two sequences of reception and transmission mini-slots 42 and 46. The second DRP WUSB slot 34 includes three MMC frames 50, 52 and 54 and three sequences of reception and transmission mini-slots 51, 53 and 55.

MBOA specifications differ than the WUSB specifications. There is a need to provide methods and apparatuses that can operate according to both specifications.

### SUMMARY OF THE INVENTION

A method for exchanging information over a wireless network, the method includes: (i) providing a distributed media access controller and a high communication layer component, the high communication layer component includes a high communication layer hardware and a high communication layer software; and (ii) utilizing the distributed media access controller and the high communication layer component to exchange information. The utilizing includes applying a centralized media access control scheme by the high communication layer component and executing at least one routine by a hardware routine execution module of the high communication layer hardware.

A method for exchanging information over a wireless network, the method includes: (i) providing a distributed media access controller and a high communication layer component, the high communication layer component includes a high communication layer hardware and a high communication layer software; and (ii) utilizing the distributed media access controller and the high communication layer component to exchange information. The utilizing includes applying a centralized media access control scheme by the high communication layer component, maintaining at least one endpoint data structure by the high communication layer software and maintaining at least one transfer operational list data structure by the high communication layer hardware.

An apparatus that includes a distributed media access controller and a high communication layer component. The high communication layer component includes a high communication layer hardware and a high communication layer software. The high communication layer component hardware includes a hardware routine execution module. The distributed media access controller and the high communication layer component are adapted to exchange information. The high communication layer component is adapted to apply a centralized media access control scheme.

An apparatus that includes a distributed media access controller and a high communication layer component. The high communication layer component includes a high communication layer hardware and a high communication layer software. The distributed media access controller and the high communication layer component are adapted to exchange information. The high communication layer component is adapted to apply a centralized media access control scheme. The high communication layer software is adapted to maintain at least one endpoint data structure and the high communication layer hardware is adapted to maintain at least one transfer operational list data structure.

### BRIEF DESCRIPTION OF THE DRAWINGS

The present invention will be understood and appreciated more fully from the following detailed description taken in conjunction with the drawings in which:

FIG. 1 illustrates an MBOA network and a WUSB network;

FIG. 2 illustrates a super frame;

FIG. 3 illustrates a hybrid ultra wide band apparatus, according to an embodiment of the invention;

FIG. 4 illustrates a transmitter endpoint data structure according to an embodiment of the invention;

FIG. 5 illustrates a transmission window (TW) data structure according to an embodiment of the invention;

FIG. 6 illustrates a TW pointers table according to an embodiment of the invention;

FIG. 7 illustrates a HCL data structure according to an embodiment of the invention;

FIG. 8 illustrates a device data structure and a host data structure according to an embodiment of the invention;

FIG. 9 illustrates an interrupt data structure according to an embodiment of the invention;

FIGS. 10a-10b illustrate instructions, according to various embodiments of the invention;

FIG. 11 is a flow chart of a method for managing an exchange of information between multiple wireless components, according to an embodiment of the invention; and

FIGS. 12-13 are flow charts of methods for managing multiple components, according to various embodiment of the invention.

### DETAILED DESCRIPTION OF THE DRAWINGS

For convenience of explanation it is assumed that the distributed media access control scheme is an MBOA MAC compliant scheme and that the centralized MAC scheme is a WUSB MAC compliant scheme. It is noted that according to various embodiments of the invention the described apparatuses and methods can be applied to other distributed and centralized MAC schemes.

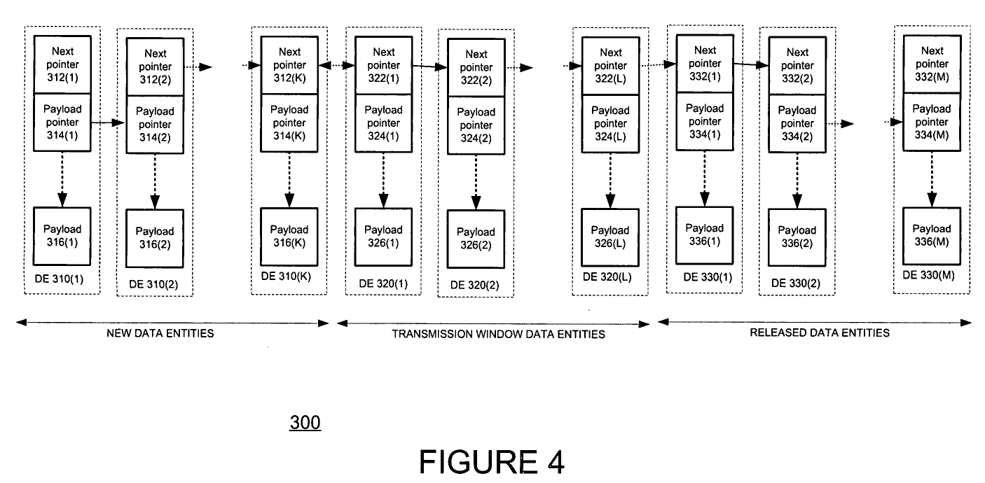

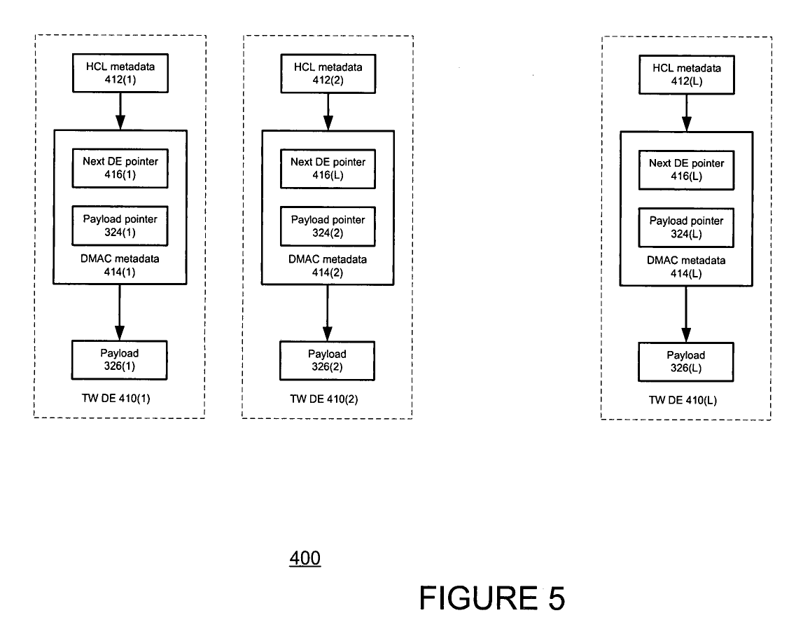

For convenience of explanation FIGS. 4 and 5 illustrates apparatuses that have only one PHY layer component, one MAC layer component and one high communication layer (HCL) component such as a frame convergence sub layer (FCSL) component.

It is noted that usually each of these components represent multiple software and hardware components and that some components can service more than a single layer. It is further noted that the HCL layer component can be replaced by another component that applies operations of another layer. It is further noted that various other components were omitted for simplicity of explanation. These omitted components can include application PHY and MAC layer components, and various layer management entities.

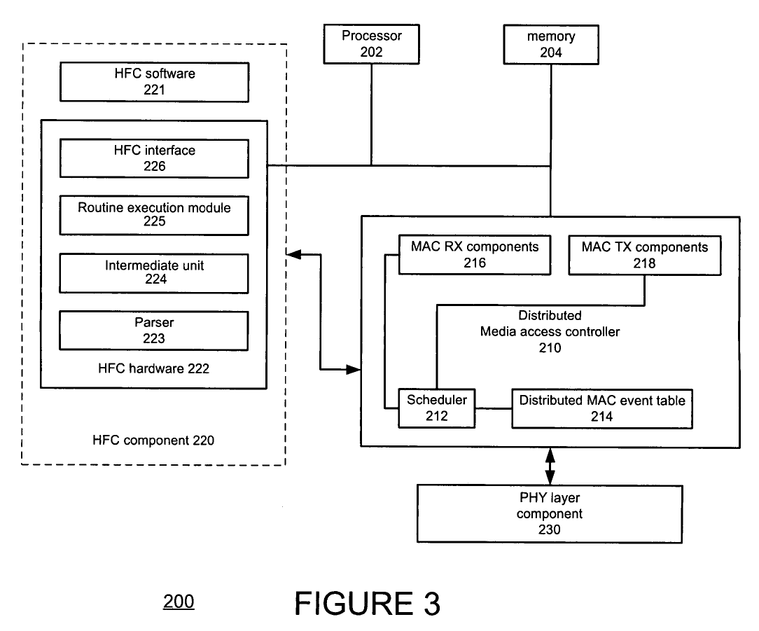

FIG. 3 illustrates a hybrid ultra wide band apparatus 200, according to an embodiment of the invention.

The hybrid ultra wide band apparatus 200 is adapted to participate in a distributed media access control scheme and is also adapted to control the access of access controlled media access apparatuses to a shared wireless medium. The term hybrid refers to the capability of apparatus 200 to participate in both types of media access control schemes. In a sense apparatus 200 can be viewed as a dual purpose apparatus.

Conveniently, the development and design of apparatus 200 can be simplified by using an existing MBOA MAC component, such as distributed media access controller 210, and feeding the distributed media access controller 210 with WUSB events.

Apparatus 200 includes distributed media access controller (DMAC) 210, HCL hardware 220, memory 204, processor 202, PHY layer component 230 and DMA controller 206. These components can be connected to each other by a shared bus, but this is not necessarily so. The processor 202 can execute various computer codes, such as but not limited to HCL software 221. The codes can be stored in a computer readable medium such as memory 204.

MBOA media access controllers are known in the art and can have various configurations. For example, Wisair Ltd. of Tel Aviv, Israel manufactures MBOA MAC layer chips. The inventors used a MBOA media access controller of Wipro, India, but other MBOA media access controllers can be used.

In general, a distributed media access controller 210 includes a MAC receive path components (“RX MAC components”) 216, MAC transmit path components (“TX MAC components”) 218, a scheduler 212 and a distributed media access controller event table 214 for triggering distributed media access controller events. The events can include transmitting information, receiving information, and the like.

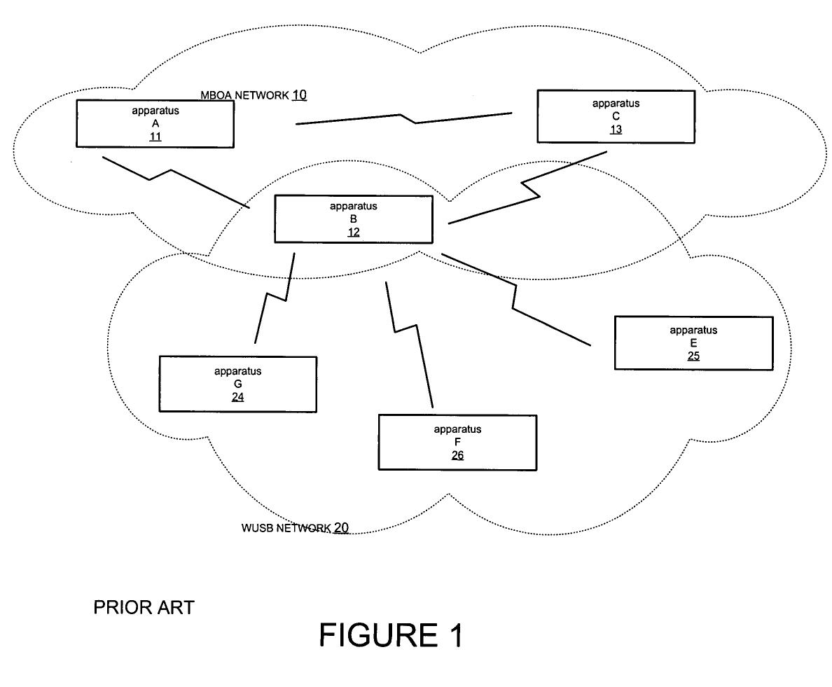

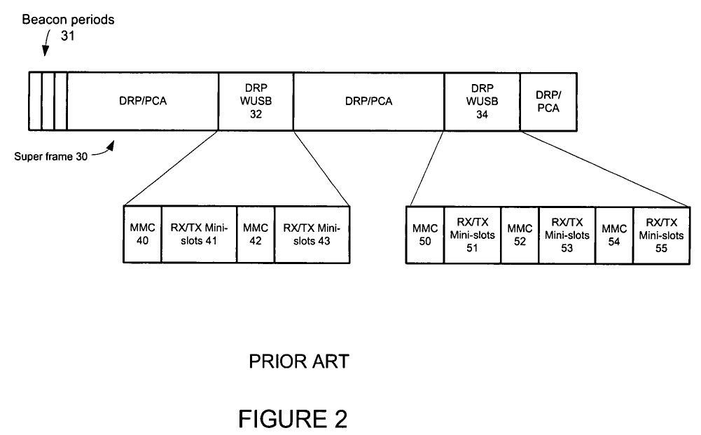

The DMAC 210 is adapted to participate in a distributed media access control scheme that allocates at least one time slot for exchanging information between a hybrid ultra wide band apparatus and multiple access controlled apparatuses. Referring to the example set forth in FIG. 1, apparatus 200 can replace apparatus B 12 and participate in a MBOA MAC scheme (along with apparatus A 11 and apparatus C 13) in order to allocate at least one time slot (like DRP WUSB time slots 32 and 34) for exchanging information with apparatuses E-G 25, 26 and 24.

The HCL component 220 includes HCL software 221 and HCL hardware 222. The HCL software 221 can be executed by a processor, such as processor 202. The HCL hardware 222 includes a parser 223, an intermediate unit 224, a routine execution module 225, and an HCL interface 226. The HCL interface 226 provides an interface between the HCL hardware 222 and the HCL software 221 and can support various data structures such as interrupt request list 810.

The intermediate unit 224 includes various storage units such as multiple FIFOs that can store multiple calls for routines and some FIFOs that can store the result of these routines. The routines are executed by the routine execution module 225.

Conveniently the HCL hardware 222 also includes a timing unit that is capable of providing timing information and also to participate in a timing compensation scheme that allows the DMAC 210 and the HCL component 220 to co-operate although they use different clocks. The timing compensation scheme is further illustrated in U.S. patent application titled “Method, apparatus and a computer readable medium for exchanging information in a hybrid environment”, filed 31 May 2005, and is incorporated herein by reference.

Conveniently, the HCL software 221 is adapted to apply a centralized media access control scheme such as but not limited to a WUSB compliant media access control scheme.

The HCL component 220 is connected to the distributed media access controller 210 and is capable of allocating multiple mini-time slots within the at least one time slot, for exchanging information between the hybrid ultra wide band apparatus 200 and the multiple access controlled apparatuses. The at least one time slot is conveniently a DRP type slot.

The HCL component 220 is further adapted to participate in a generation of distributed media access controller events in response to the allocation.

According to an embodiment of the invention the HFC software 221 generates MMC frames in which it determines the access to the wireless medium during a WUSB time slot. The WUSB time slot includes multiple mini-slots. The MMC defines the access to the shared medium on a mini-slot basis. The MMC includes timing information associated with the exchange of information between the hybrid ultra wide band apparatus and one or multiple access controlled apparatuses. Typically one WUDS event occurs per WUSB mini-slot. Conveniently, each WUSB event is associated with a start time, duration and type of event (reception, transmission).

WUSB uses a sliding window mechanism in order to synchronize between the receiver and the transmitter. The transmitter assigns sequence numbers to transmitted frames in an ascending order. The window defines the permitted range of sequence numbers to be used during a certain mini-slot. The receiver expects to receive frames that have ascending sequence numbers within a defined range. By comparing the sequence numbers of the received frames to the expected sequence numbers the receiver can determine if a transmission error occurred.

The window changes after a successful completion of reception of frames that include the sequence numbers of the previous window, after a predefined amount of failed transmission attempts, and/or after a predefine period (such as a mini-slot) expires. The size of the window (number of sequence numbers used per window) does not exceed the maximal number of frames that a certain receiver can receive in a single burst. The sequence number range are also predefined.

Assuming, for example that the sequence numbers range between one and ten and that the window size is four, then a first window can include the sequence numbers of one to four, a second window can include sequence numbers five to eight, a third window can include the sequence numbers of nine, ten one and two, a fourth window can include the sequence numbers of three to six and a fifth window can include the sequence numbers of seven to ten. Thus, during the reception of a first burst the receiver ignores frames that include sequence numbers that are greater than four, and expect to receive a sequence of frames that include the sequence numbers of one to four.

This transmission scheme is performed in a pipelined manner by the HCL software 221, HCL hardware 222 and DMAC 210. These components generate, update, link and delete (or remove) metadata that belongs to multiple layers in order to facilitate the transmission of data and control frames.

A WUSB apparatus can include multiple endpoints. An endpoint is a uniquely addressable portion of a WUSB apparatus that is the source or sink of information in a communication flow between a WUSB host and WUSB device. Thus, an endpoint can be viewed by apparatus 200 as a receiver or a transmitter, according to the communication flow direction.

At least one set of data structures is maintained for each endpoint. If a certain endpoint is a transceiver then one set of data structures is maintained for the transmitting section of the endpoint while another set of data structures is maintained for the reception section. Both data structure sets are quite similar although the data structure set associated with the transmission section (referred to as transmitter data structure) is slightly more complex, mainly due to various links between sequences of payloads that are scheduled to be transmitted during a current transmission window. For convenience of explanation the following figures will describe transmitter data structures.

For example, the transmission from a certain endpoint can be managed by maintaining a transmitter endpoint data structure 300, a TW data structure 400, a TW pointer table 500, an HCL data structure 600, and a host or device data structure 600 and 650 accordingly. The maintenance can include at least one of the following operations: writing to the data structure, updating the data structure accessing the data structure and processing at least one entry of the data structure and the like.

Apparatus 200 allows to separate between managing instant responses and managing longer (and usually more complex) tasks. The latter are managed by the routine execution module 225. The former can be managed by the parser 223.

There are various routines, such as but not limited to: (i) routines that load the current endpoint as well as various queue states especially for preparing a transmission or reception sequence, (ii) routines for storing the state of the endpoint after being serviced, (iii) routines for providing to the MAC a pointer to a data structure of a received information, (iv) routines that end the reception process and providing processed data to higher layers, (v) routines that prepare a list of payloads to transmit by the MAC and provides the MAC a start pointer, (vi) routines that end the transmission of payloads after the reception of a transmission acknowledgement message, and the like.

FIG. 4 illustrates a transmitter endpoint data structure 300 according to an embodiment of the invention. The transmitter endpoint data structure is maintained by the HCL software 221.

The data entities of the transmitter endpoint data structure 300 are classified to three classes, in response to the three-staged pipeline structure that includes DMAC 210, HCL hardware 222 and HCL software 221. The classes include new data entities (DEs) 310(1)-310(K), windowed DEs 320(1)-320(L), and released DEs 330(1)-330(M). K,L and M are positive integers.

The new DEs were generated by the EFSCL software 221 but were not yet processed by the HCL hardware 221. The HCL hardware 221 is configured to process DEs that should be transmitted during a current transmission window. Windowed DEs should be transmitted during a current transmission window. Released DEs include DEs that were successfully processed by the HCL hardware 221 and the DMAC 210. Once the window is updated (shifted) some new DEs become windowed DEs, some windowed DEs become released DEs and some released DEs are deleted.

The data entities are associated with ascending sequence numbers that are located within a predefined sequence number range.

Data structures DEs 310(1)-316(K), 326(1)-326(L), and 336(1)-336(M) include a payload (316(1)-316(K), 326(1)-326(L), and 336(1)-336(M)), a payload pointer (314(1)-314(K), 324(1)-324(L), and 334(1)-334(M)) and a pointer to the next DE (also referred to as next pointer) 312(1)-312(K), 322(1)-322(L), and 332(1)-332(M).

FIG. 5 illustrates a transmission window data structure 400 according to an embodiment of the invention. The TW data structure 400 is maintained by the HCL hardware 221.

The TW data structure 400 includes multiple TW DEs 410(1)-410(L) that are associated with frames that are scheduled to be transmitted during a current transmission window.

TW DEs 410(1)-410(L) include HCL metadata 412(1)-412(L), DMAC compliant metadata 414(1)-414(L) and payload 316(1)-316(L). The DMAC 210 views the HCL metadata 412(1)-412(L) as well as the payload 316(1)-316(L) as the MAC layer payload. The HCL metadata structures 412(1)-412(L) include a sequence number and various control and status fields such as frame size, payload size, and the like.

DMAC compliant metadata 414(1)-414(L) includes a next DE pointer 416(1)-416(L) a payload pointer 418(1)-418(L), and the like.

Each pointer out of the next DE pointers 416(1)-416(L) is calculated by the HCL hardware 221 in response to the transmission window and in response to pervious failed transmission attempts. It is noted that a receiver data structure conveniently does not include such pointers.

It is noted that PHY layer metadata can also be included within the TW DEs, either within the MAC layer payload or within the MAC layer metadata.

According to an embodiment of the invention DEs that belong to the data structures 300 and 400 point to each other using a pair of inter-data structure pointers. For convenience of explanation these inter-data structure pointers are not shown.

The various TW DEs and especially the payloads are conveniently stored in memory 204. DMAC 210 is utilized to access these data structures and to provide them to the HCL component 221.

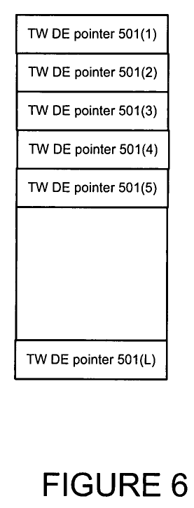

FIG. 6 illustrates a TW pointers table 500 according to an embodiment of the invention. TW pointers table 500 is maintained by the HCL hardware 221.

TW pointers table 500 includes multiple TW DE pointers 510(1)-510(L) that point to TW DEs 410(1)-410(L).

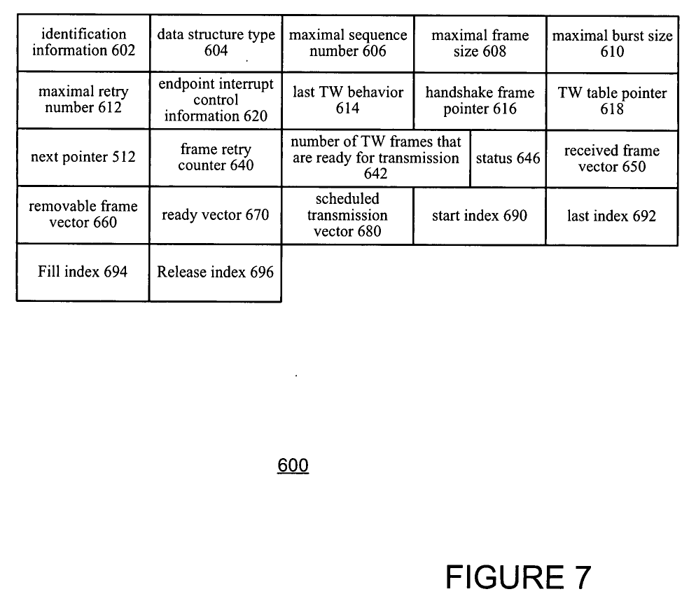

FIG. 7 illustrates a HCL data structure 600 according to an embodiment of the invention.

The HCL data structure 600 is illustrated as being associated with an endpoint data structures. According to various embodiments of the invention a substantially similar HCL data structures 600 can be associated other information types such as MMC frames, DNTS frames, status control frames and the like.

HCL data structure 600 stores the following information: identification information 602, data structure type 604, maximal sequence number 606, maximal frame size 608, maximal burst size 610, maximal retry number 612, endpoint interrupt control information 620, last TW behavior 614, handshake frame pointer 616, TW table pointer 618, next pointer 512, frame retry counter 640, number of TW frames that are ready for transmission 642, status 646, received frame vector 650, removable frame vector 660, ready vector 670, scheduled transmission vector 680, start index 690, last index 692, fill index 694 and release index 696.

The identification information 602 can identify the apparatus, the TW data structure and the like, the data structure type 604 defines the data structure type, the maximal sequence number value 606 determines the maximal value of the sequence numbers and assuming that these sequence numbers start at a predefined value (such as zero or one) defines the amount of DEs within the data structure 300. Conveniently, the value is greater than or equal to K+L+M. The maximal frame size 608 determines the maximal size of a frame. The maximal burst size 610 determines the maximal number of frames that can belong to a single burst. Conveniently the size of the transmission window equals this value. Thus, this size equals L.

The maximal retry number 612 defines the maximal amount of re-transmission attempts. The last TW behavior 614 determines whether the TW data structure enters a ready state after the last frame that is associated with the TW data structure is released, the TW table pointer 618 points to TW pointer table 500. The frame retry counter 640 counts the re-transmissions of frames. The number of TW frames that are ready for transmission 642 indicates the number of non-empty frames that should be transmitted within a current transmission window. Status 646 indicates if the TW data structure 400 is empty, ready, stalled, idle, ready to transmit and the like.

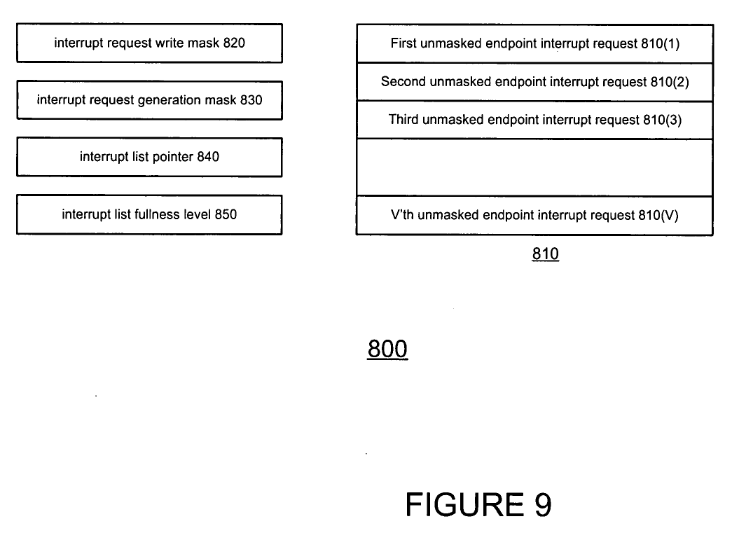

The endpoint interrupt control information 620 determines endpoint interrupt request triggering events. Conveniently the interrupt requests are written in an interrupt request list (such as interrupt request list 810 of FIG. 9). Information 620 is written by the HCL software 221 and can be read by the HCL hardware 222. Endpoint interrupt request triggering events can include: end of WUSB time slot, end of WUSB time slot and an occurrence of other endpoint request triggering events during the WUSB time slot, retry counter expiration, lack of activity during WUSB time slot, transmission of WUSB time slot during which data was conveyed, occurrence of a handshake WUSB, empty transmitter data structure, reception of acknowledge, reception failure, transmission failure, data structure ready, and the like.

An interrupt request can be generated before a certain event occurs (predicted events such as a scheduled WUSB time slot), during the event or after the event.

The endpoint interrupt control information 620 controls the interrupt requests on an end-point basis.

The transmission of frames during a transmission window, as well as filling and removal of frames from the TW data structure is controlled by using a set of control vectors. Each control vector includes multiple bits whereas each bit represents a TW DE that belongs to the TW data structure 400.

These control vectors include: received frame vector 650, removable frame vector 660, ready vector 670 and scheduled transmission vector 680.

The received frame vector 650 indicates the frames that were successfully received by a receiver that was the target of the transmissions of apparatus 200 during at least the last transmission session. A transmission session conveniently includes a transmission of a burst. A transmission window can include multiple transmission sessions.

The removable frame vector 660 indicates the TW DEs that can be removed from the TW data structure 400. The ready vector 670 indicates frames are ready for transmission. The scheduled transmission vector 680 indicates which frames should be transmitted during the next transmission session. The scheduled transmission vector indicates which frames should be included in the next transmitted burst. The scheduled transmission vector (also referred to as STV) 680 is responsive to the content of the ready vector 670 and to the content of the received frame vector 650.

Conveniently the TW DEs are filled in a sequential manner while the transmission does not necessarily occur in a sequential manner due to possible re-transmissions.

The start index (SI) 690 points to the scheduled transmission vector bit representative of the first frame that should be transmitted during the next transmission session. The last index (LI) 692 points to the scheduled transmission vector bit representative of the last frame that should be transmitted during the next transmission session. The fill index (FI) 694 points to the ready vector bit representative of the first TW DE that can receive a new frame and associated metadata. The release index (RI) 694 points to the ready vector bit representative of the first TW DE that can removed.

The filling process as well as the removal process can operate on consecutive bit sequence (representative of consecutive TW DEs), and are limited by the amount (Q) of frames that can be filled in or released during a filling and removal session. Q can be equal to L but can also differ from L. Typically Q is bigger than L.

The following table illustrates various transmissions scenarios. It is assumed that: (i) the maximal sequence number value is nine, thus each vector include nine bits; (ii) L equals four and (iii) Q equals eight.

Conveniently, the last index, fill index and removal index follow the start index. When the start index and last index are equal then there is not frame to transmit. When the start index and fill index are equal then the TW data structure is empty. When the start index equals the release index then there is no TW DE to releases.

The first row (#1) provides the initial conditions: the first till fourth frames were successfully transmitted (and received), TW DEs 410(1)-410(4) can be released, TW DEs 410(5)-410(8) should be transmitted during the next transmission sequence and TW DEs 410(5)-410(8) are ready to be transmitted while TW DE 410(9) is empty.

The second row (#2) illustrates the state of various vectors and pointers after the fifth till eight frames were successfully transmitted and TW DE 410(1)-410(4) were removed.

The third row (#3) illustrates the state of various vectors and pointers after TW DE 410(9) is filled.

The fourth row (#4) illustrates the state of various vectors and pointers after TW DE 410(1)-410(4) are released.

| | Received | Removable | | | | | | |
|---|---|---|---|---|---|---|---|---|
| # | Frame vector | frame vector | Ready vector | Scheduled tx. Vector | SI | LI | FI | RI |
| 1 | 000001111 | 000001111 | 011111111 | 011110000 | 5 | 8 | 9 | 1 |
| 2 | 011110000 | 011110000 | 000000000 | 011110000 | 5 | 9 | 9 | 1 |
| 3 | 011110000 | 000001111 | 111110000 | 011110000 | 5 | 9 | 1 | 1 |
| 4 | 011110000 | 000000000 | 111110000 | 011110000 | 5 | 9 | 1 | 5 |
| 5 | 011110000 | 000000000 | 111110111 | 011110000 | 5 | 9 | 3 | 5 |

Apparatus 200 can operate as a device or as a host. A host determines which transmission (or reception) events should occur during a WUSB timeslot and in response generate control information such as a MMC frame. A transmission to a certain endpoint utilizes the DE of that endpoint. Conveniently, the host, ad especially the HCL software 221 determines which frames to transmit, generates a MMC frame and also generates a control table that includes pointers to the DEs that participate in the events.

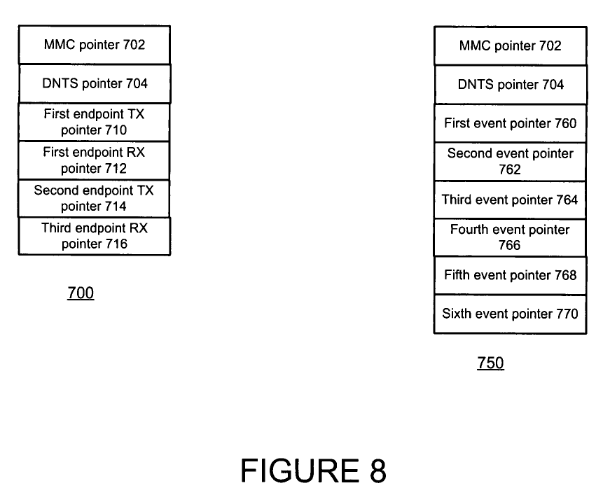

FIG. 8 illustrates a device data structure 700 and a host data structure 750 according to an embodiment of the invention. The device data structure 700 and the host data structure 750 are maintained by the HCL hardware 221.

If apparatus 200 operates as an apparatus it usually includes a limited amount of endpoints and it can manage them in an effective manner by using a device data structure 700 that include pointers to each endpoint associated data structure.

The device data structure 700 includes a MMC pointer 702, a DNTS pointer 704, multiple TX endpoint pointers 710 and 714 and multiple RX endpoint pointers 712 and 716. The number of endpoint pointers depends upon the amount of endpoints and their capabilities (receiver, transmitter or transceiver). Each RX endpoint pointer points to corresponding HCL data structure of a receiving endpoint while each TX pointer points to corresponding HCL data structure of a transmitting endpoint. The corresponding HCL data structure can be a HCL data structure 600.

MMC pointer 702 points to a queue that stores received or transmitted MMC frames. DNTS pointer 704 points to a queue that stores received or transmitted DNTS frames. DNTS frames are asynchronous frames that are transmitted from devices to a host. The host allocates a sequence of mini-slots during which devices can transmit DNTS frames. If the host successfully received a DNTS frame from a device then an appropriate acknowledgement message is sent during the next MMC frame.

A host can manage a very large amount of endpoints. In order to simplify the management scheme the host data structure includes pointers to events that should occur during the next one or more WUSB time frames. Each event is associated with an endpoint and the host data structure 750 includes pointers to data structures that are associated with endpoints that are involved in the scheduled events.

The host data structure 750 includes an MMC pointer 752, a DNTS pointer 754, multiple event pointers 762-770 that point to data structures of endpoints that are scheduled to participate in events within the next WUSB time slot. These pointers point to HCL data structure such as HCL data structure 600.

According to an embodiment of the invention apparatus 200 includes a processor such as processor 202 and an interrupt request manager such as HCL component 220. Apparatus 200 and especially HCL device 220 is adapted to selectively prevent components from generating interrupt requests. The interrupt request manager is adapted to selectively prevent writing component interrupt requests to an interrupt request list and to selectively generate interrupt requests in response to a content of the interrupt request list and in response to an interrupt request manager policy. The interrupt requests are associated with an exchange of information over a wireless network.

Apparatus 200, especially when operating as a host, should be able to manage a large amount of interrupt requests that can be generated as a response to multiple situation that are associated with a large number of endpoints data structures.

Interrupts are usually resource consuming, especially when multiple interrupt requests can be generated.

In order to control the amount of interrupts various interrupt data structures are utilized.

FIG. 9 illustrates an interrupt data structure 800 according to an embodiment of the invention.

The interrupt data structure 800 includes an interrupt request list 810, an interrupt request write mask 820, an interrupt request generation mask 830, an interrupt list pointer 840 and an interrupt list fullness level field 850.

The interrupt request list 810 stores unmasked endpoint interrupt requests such as requests 810(1)-810(V). This list can include information representative of endpoint interrupt requests. This information can be arranged in various well known arrangements including tables, arrays, and the like.

The interrupt request write mask 820 determines which interrupt requests can be written to the interrupt request list 810. The interrupt request generation mask 830 determines which endpoint interrupt requests can cause an interrupt. The interrupt list pointer 840 points to the location of the interrupt request list 810 in memory 204.

The interrupt list fullness level field 850 stores the number of valid interrupt requests in the interrupt request list 810. Each time the HCL hardware 222 writes a new interrupt request to list this value in increased. When the HCL software 221 reads an interrupt request from the list 810 this value is decremented.

Conveniently, the interrupt request write mask 820 and an interrupt request generation mask 830 can mask interrupt requests based upon the class of the interrupt request—the class of the interrupt request triggering events.

Each class can include one or more interrupt request triggering events. A first class is referred to as a common class and can include: beginning of a WUSB time slot, end of a WUSB time slot, end of DRP slot, WUSB channel time wrap around, and the like.

A second class is referred to as a transfer indication class and can include: transmission of MMC frame, transmission of DNTS frame, transmission of data, transmit failure, receive failure, idle WUSB time slot and the like.

A third class is also referred to as flow control class and can include: idle WUSB slot, data structure not ready, reception or transmission of NAK messages (non-acknowledge), reception or transmission of acknowledge frame, reception or transmission of stall message, reception or transmission of acknowledge frame with a flow control indication, reception or transmission of status control acknowledgement message, and the like.

A fourth class is also referred to as data structure management class and can include: addition of TW DE, removal of TW DE, empty TW data structure, transmission of last TW DE, and the like.

A fifth class is also referred to as MMC error group and can include failed MMC transmissions, and the like.

The HCL hardware 222 can send an interrupt request to processor 202 if the interrupt request list includes one or more interrupt requests that are not masked by the interrupt request generation mask 830.

According to an embodiment of the invention the HCL software 221 can access the interrupt request list 810 even when such an interrupt request was not generated. It can read the list 810 in various manners including but not limited to periodical manner, random manner, pseudo-random manner, in response to various events, and the like.

According to an embodiment of the invention the interrupt request list 810 (or at least a portion of the list) are read when the end of a mini-slot ends or if one or more new interrupt requests were written to the list during the mini-slot.

Apparatus 200 can operate as a host or as an apparatus. A device has to receive MMC frames, process them and be prepared to receive or transmit frames during WUSB time slots that are allocated to apparatus 200.

According to an embodiment of the invention the DMAC 210 receives frames from the PHY component 230 and provides the frame to the HCL component 220. The HCL hardware 222, and especially its parser, detects the frame type.

When an MMC frame is detected the HCL component 220 processes it to provide a list of instructions, each corresponding to one mini-slot. The HCL component 220 then sends the list to the DMAC 210 that in turn sends the HCL component 220 instructions according to the time stamps included within the instruction.

For example, if according to a certain MMC frame an apparatus 200 should exchange information during three mini-slots (that start as about T1, T2 and T3) then the following stages should occur:

(i) HCL component 220 processes that MMC frame and generated three instructions, one instruction for each WUSB event (for each mini-slot). These three instructions are associated with time stamps of T1, T2 and T3.

(ii) The HCL component 220 sends the three instructions to DMAC 210.

(iii) At T1 or slightly before T1 DMAC 210 sends the first instruction to HCL component 220. The HCL component 220 utilizes the first instruction to either transmit or receive information during the first mini-slot allocated to apparatus 200.

(iv) At T2 or slightly before T2 DMAC 210 sends the second instruction to HCL: component 220. The HCL component 220 utilizes the second instruction to either transmit or receive information during the second mini-slot allocated to apparatus 200.

(v) At T3 or slightly before T3 DMAC 210 sends the third instruction to HCL component 220. The HCL component 220 utilizes the third instruction to either transmit or receive information during the third mini-slot allocated to apparatus 200.

It some cases the DMAC 210 can send a preliminary indication signal to the HCL hardware 222 indicating that a certain event is about to start. Once the event starts (for example a certain data frame is received) the HCL hardware 222 can manage the reception process by providing a pointer to the relevant TW DE, execute a routine and the like. One of the routine is “get a pointer” routine in which the HCL hardware provides the pointer to the relevant TW DE.

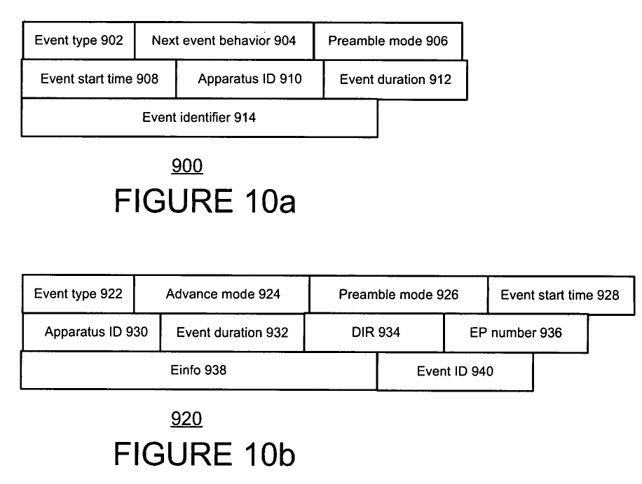

FIG. 10a illustrates an instruction 900, according to an embodiment of the invention.

Instruction 900 includes an event type 902, next event behavior 904, preamble mode 906, event start time 908, apparatus ID 910, event duration 912, event identifier 914.

The event type 902 indicates if the event is a transmission event, a reception event or an entrance to a low power mode event. The next event behavior 904 indicates if the apparatus 200 should jump to the next event once the duration expires, whether to wait to the next MMC frame. The preamble mode 906 indicates if the preamble is a long MAC preamble or a short one or can indicate the ratio between short and long preambles in a series of frames.

The event start time 908 indicates when the event should start. The apparatus ID 910 indicates the identity of the apparatus that should exchange information with apparatus 200.

The event identifier 914 includes an event ID, an event type (whether the information is data, MMC frame, DNTS frame, a handshake frame, a status control frame, and the like), the endpoint and whether it involves transmitting information to a host or receiving information to a host.

As mentioned above the HCL hardware 222 processes the MMC frames. Conveniently, the HCL software 221 also can utilizes the MMC frame for its purposes. In order to reduce the load of computer 202 the HCL hardware provides control field location information such as but not limited to a MMC table that indicates the offset within the MMC frame and the information type of each event related information. Thus, the HCL software does not have to perform a parsing process and rather reads the MMC table and extracts the relevant information. The MMC table also includes an indication of the number of valid entries in the MMC table.

FIG. 10b illustrates an instruction 920, according to an embodiment of the invention.

Instruction 920 includes an event type 922, advance mode 924, preamble mode 926, event start time 928, apparatus ID 930, event duration 932, DIR 934, EP number 936, Einfo 938 and event ID 940.

Advance mode 924 indicates if micro scheduler shall advance to the next event—when a duration counter expires, when it receives an MMC frame, when an end of a DRP frame occurs. DIR 934 indicates the direction of information propagation—IN or OUT. EP number 936 is the number of the endpoint that is used by the event. Einfo 936 includes information about the event it is used to help the device to allocate the queue head when it receives it back during a micro-scheduled event cycle: it can define the received signals as data, MMC frame, DNTS frame, handshake frame, status control frame, and the like.

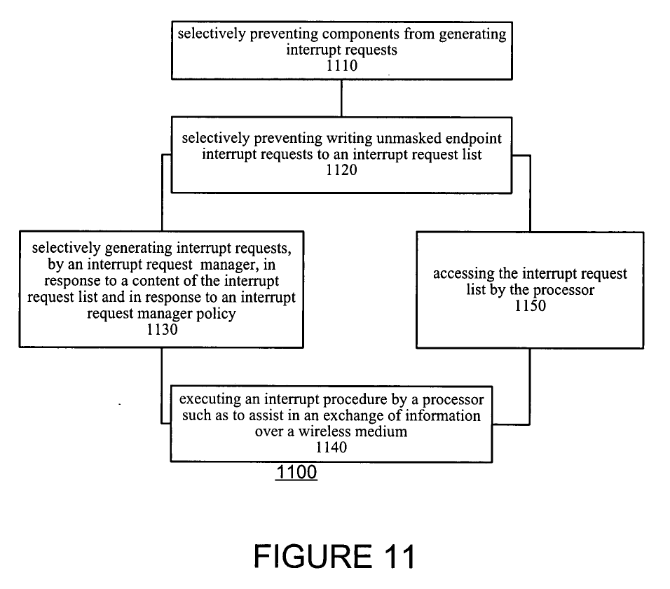

FIG. 11 is a flow chart of a method 1100 for managing an exchange of information between multiple wireless components, according to an embodiment of the invention.

Conveniently, these component are capable of exchanging information in compliance with the WUSB standard. Additionally or alternatively, these components can be ultra wide band apparatuses. A single apparatus can include multiple components such as endpoints.

Method 1100 starts by stage 1110 of selectively preventing components from generating interrupt requests. The prevention scheme is determined on a component to component basis, Thus different components can be associated with different prevention policies. Conveniently, preventions scheme is defined by writing to component associated data structures such as but not limited to HCL data structures. Conveniently, the prevention is responsive to a class of the component interrupt requests. According to an embodiment of the invention the masking is determined by writing endpoint interrupt control information 620.

Conveniently, stage 1110 is preceded by a stage of defining for each component a component interrupt request prevention policy.

Stage 1110 is followed by stage 1120 of selectively preventing writing endpoint interrupt requests to an interrupt request list. According to an embodiment of the invention the prevention is determined by writing to the interrupt request write mask 820. Conveniently, this writing prevention policy is shared by the components that are managed by the same interrupt request manager.

Stage 1120 is followed by stages 1130 and 1150. Stage 1130 includes selectively generating interrupt requests, by an interrupt request manager, in response to a content of the interrupt request list and in response to an interrupt request manager policy. Conveniently, the interrupt request manager policy is responsive to a class of unmasked component interrupt requests. According to an embodiment of the invention the interrupt request manager policy is determined by writing to the interrupt request generation mask 830. The interrupt request manager can be included within the HCL interface 226.

Stage 1130 is followed by stage 1140 of executing an interrupt procedure by a processor such as to assist in an exchange of information over a wireless medium. Stage 1140 can be initiated by a reception of an interrupt request generated by the interrupt request manager.

Stage 1150 includes accessing the interrupt request list by the processor. Thus, interrupts can be initiated even if the interrupt manager did not generate an interrupt request to the processor. Conveniently, interrupts are generated near the end of time slots, or near the end of a time slot during which unmasked endpoint interrupt requests were written to the interrupt request list during the time slot.

Stage 1150 is followed by stage 1140.

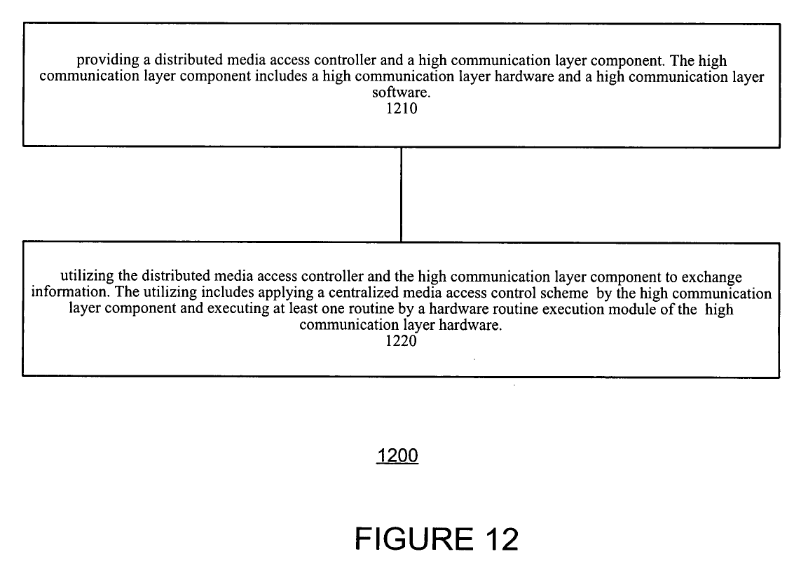

FIG. 12 is a flow chart of a method 1200 for exchanging information over a wireless network, according to an embodiment of the invention.

Method 1200 starts by stage 1210 of providing a distributed media access controller and a high communication layer component; the high communication layer component includes a high communication layer hardware and a high communication layer software.

Stage 1210 is followed by stage 1220 of utilizing the distributed media access controller and the high communication layer component to exchange information. Stage 1220 includes applying a centralized media access control scheme by the high communication layer component and executing at least one routine by a hardware routine execution module of the high communication layer hardware.

Conveniently stage 1220 includes maintaining a set of control vectors. The control vectors are used to control the transmission of frames and the filling and removal of frames.

Conveniently, the control vectors include a received frame vector, a removable frame control vector, and a scheduled transmission vector. Conveniently, the control vectors further include a ready vector.

Conveniently, stage 1220 includes applying a sequential frame fill and removal process as well as applying a frame transmission process that includes re-transmission of frames. The re-transmission can compensate for transmission or reception errors. The re-transmission can be limited by a maximal re-transmission threshold. Conveniently when a certain frame is re-transmitted the burst that include this frame can include a sequence of non-consecutive frames. According to an embodiment of the invention the HCL hardware 222 dynamically updates pointers that point to the next frame to be transmitted or to data structures associated with that frame.

Conveniently, stage 1220 includes applying, on received frames, substantially parallel frame processing sessions by the high communication layer component and by distributed media access controller. The controller and component can receive the received frames and apply various operations substantially in parallel.

According to an embodiment of the invention stage 1220 includes processing a control frame by the high communication layer component to provide a set of instructions; providing the instructions to the distributed media access controller, and providing each instruction to the high communication layer component according to timing information included within the instruction.

According to an embodiment of the invention stage 1220 includes generating control field location information by the high communication layer hardware and providing said information to the high communication layer software.

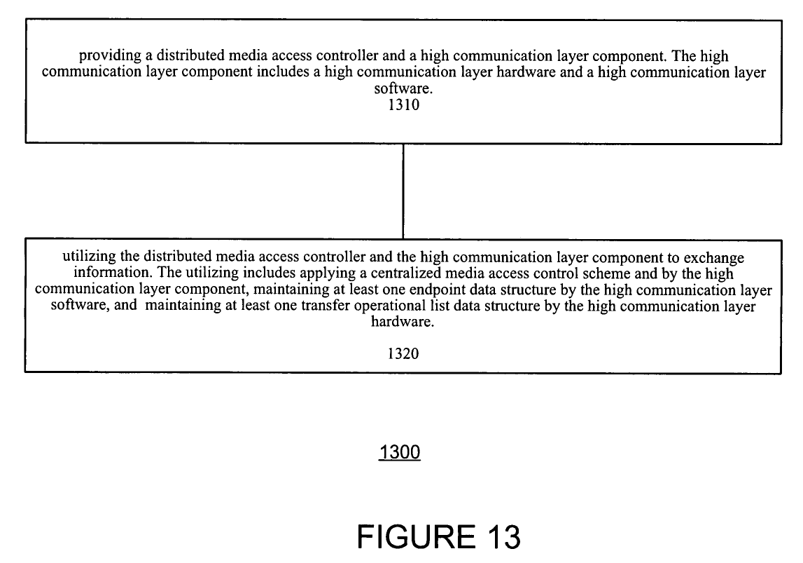

FIG. 13 is a flow chart of a method 1300 for exchanging information over a wireless network, according to an embodiment of the invention.

Method 1300 starts by stage 1310 of providing a distributed media access controller and a high communication layer component; the high communication layer component includes a high communication layer hardware and a high communication layer software.

Stage 1310 is followed by stage 1320 of utilizing the distributed media access controller and the high communication layer component to exchange information. Stage 1320 includes applying a centralized media access control scheme and by the high communication layer component, maintaining at least one endpoint data structure by the high communication layer software, and maintaining at least one transfer operational list data structure by the high communication layer hardware.

Stage 1320 conveniently includes embedding high communication layer information within centralized media access controller compliant data structures.

Stage 1320 conveniently includes maintaining at least one of the following data structures: high communication layer data structure, TW pointers table, host data structure, and a device data structure.

Stage 1320 conveniently includes maintaining a set of control vectors. The control vectors are used to control the transmission of frames and the filling and removal of frames.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim:

1. A method for exchanging information over a wireless network, the method comprises: providing a distributed media access controller and a high communication layer component; wherein the high communication layer component comprises a high communication layer hardware and a high communication layer software; and utilizing the distributed media access controller and the high communication layer component to exchange information; wherein the utilizing comprises applying a centralized media access control scheme and by the high communication layer component; and wherein the utilizing comprises executing at least one routine by a hardware routine execution module of the high communication layer hardware.

2. The method according to claim 1 wherein utilizing comprises maintaining a set of control vectors.

3. The method according to claim 2 wherein the control vectors comprise a received frame vector, a removable frame control vector, and a scheduled transmission vector.

4. The method according to claim 2 wherein the control vectors further comprise a ready vector.

5. The method according to claim 2 further comprising applying a sequential frame fill and removal process as well as applying a frame transmission process that includes re-transmission of frames.

6. The method according to claim 1 wherein the utilizing comprises applying, on received frames, substantially parallel frame processing sessions by the high communication layer component and by distributed media access controller.

7. The method according to claim 1 wherein the utilizing comprises:
processing a control frame by the high communication layer component to provide a set of instructions;
providing the instructions to the distributed media access controller, and providing each instruction to the high communication layer component according to timing information included within the instruction.

8. The method according to claim 1 wherein the utilizing comprises generating control field location information by the high communication layer hardware and providing said information to the high communication layer software.

9. A method for exchanging information over a wireless network, the method comprises: providing a distributed media access controller and a high communication layer component; wherein the high communication layer component comprises a high communication layer hardware and a high communication layer software; and utilizing the distributed media access controller and the high communication layer component to exchange information; wherein the utilizing comprises applying a centralized media access control scheme and by the high communication layer component; and wherein the utilizing comprises maintaining at least one endpoint data structure by the high communication layer software while maintaining at least one transfer operational list data structure by the high communication layer hardware.

10. The method according to claim 9 wherein utilizing comprises embedding high communication layer information within centralized media access controller compliant data structures.

11. The method according to claim 9 wherein the utilizing further comprises maintaining at least one high communication layer data structure.

12. The method according to claim 9 wherein utilizing comprises maintaining at least one TW pointers table.

13. The method according to claim 9 further comprising maintaining a host data structure.

14. The method according to claim 9 wherein the utilizing comprises maintaining a set of control vectors.

15. An apparatus, comprising a distributed media access controller and a high communication layer component; wherein the high communication layer component comprises a high communication layer hardware and a high communication layer software, and the high communication layer component hardware comprises a hardware routine execution module; wherein the distributed media access controller and the high communication layer component are adapted to exchange information; wherein the high communication layer component is adapted to apply a centralized media access control scheme.

16. The apparatus according to claim 15 wherein the high communication layer component is adapted to maintain a set of control vectors.

17. The apparatus according to claim 16 wherein the control vectors comprise a received frame vector, a removable frame control vector, and a scheduled transmission vector.

18. The apparatus according to claim 16 wherein the control vectors further comprise a ready vector.

19. The apparatus according to claim 16 wherein the high communication layer component is adapted to apply a sequential frame fill and removal process as well as apply a frame transmission process that includes re-transmission of frames.

20. The apparatus according to claim 15 wherein high communication layer component and by distributed media access controller are adapted to apply, on received frames, substantially parallel frame processing sessions.

21. The apparatus according to claim 15 wherein the high communication layer component is adapted to process a control frame to provide a set of instructions and to provide the instructions to the distributed media access controller; and wherein the distributed media access controller is adapted to provide each instruction to the high communication layer component according to timing information included within the instruction.

22. The apparatus according to claim 15 wherein the high communication layer hardware is adapted to generate control field location information and to providing said information to the high communication layer software.

23. An apparatus, comprising a distributed media access controller and a high communication layer component; wherein the high communication layer component comprises a high communication layer hardware and a high communication layer software; wherein the distributed media access controller and the high communication layer component are adapted to exchange information; wherein the high communication layer component is adapted to apply a centralized media access control scheme; and wherein the high communication layer software is adapted to maintain at least one endpoint data structure and the high communication layer hardware is adapted to maintain at least one transfer operational list data structure.

24. The apparatus according to claim 23 wherein the high communication layer is adapted to embed high communication layer information within centralized media access controller compliant data structures.

25. The apparatus according to claim 23 wherein the high communication layer component is adapted to maintain at least one high communication layer data structure.

26. The apparatus according to claim 23 wherein high communication layer component is adapted to maintain at least one TW pointers table.

27. The apparatus according to claim 23 further adapted to maintain a host data structure.

28. The apparatus according to claim 23 further adapted to maintain a set of control vectors.
